(19) United States
(12) Patent Application Publication
(10) Pub. No.: US 2021/0166040 A1
(43) Pub. Date: Jun. 3, 2021

(54) METHOD AND SYSTEM FOR DETECTING COMPANIONS, ELECTRONIC DEVICE AND STORAGE MEDIUM

(71) Applicant: BEIJING SENSETIME TECHNOLOGY DEVELOPMENT CO., LTD., Beijing (CN)

(72) Inventors: Yongzhi GUO, Beijing (CN); Jiayu MA, Beijing (CN); Xiya ZHONG, Beijing (CN)

(21) Appl. No.: 17/166,041

(22) Filed: Feb. 3, 2021

Related U.S. Application Data
(63) Continuation of application No. PCT/CN2020/105560, filed on Jul. 29, 2020.

(30) Foreign Application Priority Data
Nov. 15, 2019 (CN) 201911120558.2

(51) Int. Cl. G06K 9/00; G06T 7/246

(52) U.S. Cl. CPC G06K 9/00778; G06K 9/00288; G06K 9/00677; G06T 7/246; G06K 9/00369

(57) ABSTRACT

The present disclosure relates to a method and system for detecting companions, an electronic device and a storage medium. The method includes: obtaining video images respectively captured by a plurality of image capture devices deployed in different areas during a preset time period; performing person detection on the video images, to determine, according to an obtained person detection result, an image set corresponding to at least one person among a plurality of persons, the image set including person images; determining track information of the at least one person according to position information of the plurality of image capture devices, the image set corresponding to the at least one person, and time for capturing the person images; and determining companions among the plurality of persons according to track information of the plurality of persons. According to the embodiments of the present disclosure, the accuracy of detection on the companions can be improved.

### CROSS-REFERENCE TO RELATED APPLICATION

The present application is a continuation of and claims priority under 35 U.S.C. 120 to PCT Application. No. PCT/CN2020/105560, filed on Jul. 29, 2020, which claims priority of Chinese Patent Application entitled “Method, Apparatus and System for Detecting Companions, Electronic Device and Storage Medium” filed to the Patent Office of China on Nov. 15, 2019, with the Application No. 201911120558.2. All the above-referenced priority documents are incorporated herein by reference in their entirety.

### TECHNICAL FIELD

The present disclosure relates to the technical field of computers, and more particularly, to a method, apparatus and system for detecting companions, an electronic device and a storage medium.

### BACKGROUND

Companions are a certain number of people who are at the store in a similar time period, focus on the same products and possess a centralized right for making purchase decisions. It is very important for some retail industries to recognize companions. For instance, for such industries with high product value and low purchase frequency as 4S stores, jewelry stores and real estates, recognition on the companions is crucial to improve customer experience and save manpower cost. In a related art, a face recognition method may also be used to recognize companions. The method is to capture face images based on image capture devices at fixed positions, and determine pedestrians recognized within a preset time interval as the companions.

### SUMMARY

The present disclosure provides technical solutions of a method for detecting companions, which can improve the accuracy of recognition on the companions.

According to one aspect of the present disclosure, there is provided a method for detecting companions, comprising:

obtaining video images respectively captured by a plurality of image capture devices deployed in different areas during a preset time period;

performing person detection on the video images, to determine, according to an obtained person detection result, an image set corresponding to at least one person among a plurality of persons, the image set including person images;

determining track information of the at least one person according to position information of the plurality of image capture devices, the image set corresponding to the at least one person, and time for capturing the person images; and

determining companions among the plurality of persons according to track information of the plurality of persons.

In a possible implementation, determining the track information of the at least one person according to the position information of the plurality of image capture devices, the image set corresponding to the at least one person, and time for capturing the person images includes:

determining, for at least one person image in the image set corresponding to the at least one person, first position information of a target person in the person image in a video image corresponding to the person image;

determining a spatial position coordinate of the target person in a spatial coordinate system according to the first position information and second position information, the second position information being position information of an image capture device for capturing the video image corresponding to the person image;

obtaining a spatio-temporal position coordinate of the target person in a spatio-temporal coordinate system according to the spatial position coordinate and time for capturing the video image corresponding to the person image; and

obtaining the track information of the at least one person in the spatio-temporal coordinate system according to spatio-temporal position coordinates of the plurality of persons.

In a possible implementation, determining companions among the plurality of persons according to track information of the plurality of persons includes:

clustering the track information of the plurality of persons to obtain at least one cluster set; and

determining persons respectively corresponding to a plurality of pieces of track information belonging to the same cluster set as a group of companions.

In a possible implementation, the track information of the at least one person includes a point group in the spatio-temporal coordinate system; and

determining companions among the plurality of persons according to track information of the plurality of persons includes:

determining similarity for point groups corresponding to every two persons in the spatio-temporal coordinate system in the track information of the plurality of persons;

determining a plurality of person pairs based on a relationship between the similarity and a first similarity threshold, each person pair including two persons, and the similarity for each person pair having a value greater than the first similarity threshold; and

determining at least one group of companions according to the plurality of person pairs.

In a possible implementation, determining at least one group of companions according to the plurality of person pairs includes:

establishing a companion set according to a first person pair in the plurality of person pairs;

determining an associated person pair from at least one second person pair, other than the person pair included in the companion set, in the plurality of person pairs, the associated person pair including at least one person in the companion set;

adding the associated person pair to the companion set; and

determining persons in the companion set as a group of companions.

In a possible implementation, adding the associated person pair to the companion set includes:

determining a number of person pairs including a first person in the associated person pairs; and

adding the associated person pair to the companion set in a case where the number of person pairs including the first person is less than a number-of-person-pairs threshold.

In a possible implementation, after determining the at least one group of companions according to the plurality of person pairs, the method further comprising:

determining, in a case where the number of persons included in the group of companions is greater than a first number threshold, at least one person pair having a value of the similarity greater than a second similarity threshold in the plurality of person pairs as a group of companions, such that the number of persons included in the group of companions is less than the first number threshold, the second similarity threshold being greater than the first similarity threshold.

In a possible implementation, determining similarity for point groups corresponding to every two persons in the spatio-temporal coordinate system in the track information of the plurality of persons includes:

determining a spatial distance between at least one first spatio-temporal position coordinate corresponding to a first person of the every two persons in the spatio-temporal coordinate system and at least one second spatio-temporal position coordinate corresponding to a second person of the every two persons in the spatio-temporal coordinate system;

determining a first number of first spatio-temporal position coordinates corresponding to spatial distances less than or equal to a distance threshold, and a second number of second spatio-temporal position coordinates corresponding to spatial distances less than or equal to the distance threshold;

determining a first ratio of the first number to a total number of first spatio-temporal position coordinates, and a second ratio of the second number to a total number of second spatio-temporal position coordinates; and

determining a maximum value of the first ratio and the second ratio as the similarity between the two persons.

In a possible implementation, performing person detection on the video images, to determine, according to the obtained person detection result, the image set corresponding to at least one person among a plurality of persons includes:

performing the person detection on the video images to obtain person images including detection information, the person detection including at least one of face detection and body detection, wherein in a case where the person detection includes the face detection, the detection information includes face information; and in a case where the person detection includes the body detection, the detection information includes body information; and

determining, according to the person images, the image set corresponding to the at least one person among the plurality of persons.

In a possible implementation, determining, according to the person images, the image set corresponding to the at least one person among the plurality of persons includes:

clustering the person images including the face information to obtain a face clustering result, the face clustering result including at least one face identity for the person images including the face information;

clustering the person images including the body information to obtain a body clustering result, the body clustering result including at least one body identity for the person images including the body information; and

determining, according to the face clustering result and the body clustering result, the image set corresponding to the at least one person among the plurality of persons.

In a possible implementation, determining, according to the face clustering result and the body clustering result, the image set corresponding to the at least one person among the plurality of persons includes:

determining corresponding relationships between face identities and body identities in at least one person image including the face information and the body information; and

obtaining, according to a first corresponding relationship in the corresponding relationships, person images including the face information and/or the body information in the first corresponding relationship from the person images to form an image set corresponding to one person.

In a possible implementation, determining corresponding relationships between face identities and body identities in at least one person image including the face information and the body information includes:

obtaining face identities corresponding to the face information and body identities corresponding to the body information in the person images including the face information and the body information;

grouping the person images including the face information and the body information according to body identities to which the person images correspond, to obtain at least one body image group, person images in the same body image group having the same body identity; and

determining, for a first body image group in the body image groups, face identities respectively corresponding to at least one person image in the first body image group, and determining, according to the number of person images corresponding to at least one face identity in the first body image group, corresponding relationships between face identities and body identities in the person images in the first body image group.

In a possible implementation, determining corresponding relationships between face identities and body identities in at least one person image including the face information and the body information includes:

obtaining face identities corresponding to the face information and body identities corresponding to the body information in the person images including the face information and the body information;

grouping the person images including the face information and the body information according to face identities to which the person images correspond, to obtain at least one face image group, person images in the same face image group having the same face identity; and

determining, for a first face image group in the face image groups, body identities respectively corresponding to at least one person image in the first face image group, and determining, according to the number of person images corresponding to at least one body identity in the first face image group, corresponding relationships between face identities and body identities in the person images in the first face image group.

In a possible implementation, determining, according to the face clustering result and the body clustering result, the image set corresponding to the at least one person among the plurality of persons includes:

determining, for person images including the face information and not belonging to the image set, an image set corresponding to at least one person according to face identities of the person images.

In a possible implementation, after determining companions among the plurality of persons according to the track information of the plurality of persons, the method further comprises at least one of:

determining a marketing plan for the companions according to the companions among the plurality of persons; and

determining an abnormal person among the companions.

According to one aspect of the present disclosure, there is provided an apparatus for detecting companions, comprising:

an obtaining module, configured to obtain video images respectively captured by a plurality of image capture devices deployed in different areas during a preset time period;

a first determination module, configured to perform person detection on the video images obtained by the obtaining module to determine, according to an obtained person detection result, an image set corresponding to at least one person among a plurality of persons, the image set including person images;

a second determination module, configured to determine track information of the at least one person according to position information of the plurality of image capture devices, the image set corresponding to the at least one person and obtained by the second determination module, and time for capturing the person images; and

a third determination module, configured to determine companions among the plurality of persons according to track information of the plurality of persons that is obtained by the second determination module.

In a possible implementation, the second determination module is further configured to:

determine, for at least one person image in the image set corresponding to the at least one person, first position information of a target person in the person image in a video image corresponding to the person image;

determine a spatial position coordinate of the target person in a spatial coordinate system according to the first position information and second position information, the second position information being position information of an image capture device for capturing the video image corresponding to the person image;

obtain a spatio-temporal position coordinate of the target person in a spatio-temporal coordinate system according to the spatial position coordinate and time for capturing the video image corresponding to the person image; and

obtain the track information of the at least one person in the spatio-temporal coordinate system according to spatio-temporal position coordinates of the plurality of persons.

In a possible implementation, the third determination module is further configured to:

cluster the track information of the plurality of persons to obtain at least one cluster set; and

determine persons respectively corresponding to a plurality of pieces of track information belonging to the same cluster set as a group of companions.

In a possible implementation, the track information of the at least one person includes a point group in the spatio-temporal coordinate system; and the second determination module is further configured to:

determine companions among the plurality of persons according to track information of the plurality of persons, including:

determine similarity for point groups corresponding to every two persons in the spatio-temporal coordinate system in the track information of the plurality of persons;

determine a plurality of person pairs based on a relationship between the similarity and a first similarity threshold, each person pair including two persons, and the similarity for each person pair having a value greater than the first similarity threshold; and

determine at least one group of companions according to the plurality of person pairs.

In a possible implementation, the second determination module is further configured to:

establish a companion set according to a first person pair in the plurality of person pairs;

determine an associated person pair from at least one second person pair, other than the person pair included in the companion set, in the plurality of person pairs, the associated person pair including at least one person in the companion set;

add the associated person pair to the companion set; and

determine persons in the companion set as a group of companions.

In a possible implementation, the second determination module is further configured to:

determine a number of person pairs including a first person in the associated person pairs; and

add the associated person pair to the companion set in a case where the number of person pairs including the first person is less than a number-of-person-pairs threshold.

In a possible implementation, the apparatus further comprises:

a fourth determination module, configured to determine, in a case where the number of persons included in the group of companions is greater than a first number threshold, at least one person pair having a value of the similarity greater than a second similarity threshold in the plurality of person pairs as a group of companions, such that the number of persons included in the group of companions is less than the first number threshold, the second similarity threshold being greater than the first similarity threshold.

In a possible implementation, the second determination module is further configured to:

determine a spatial distance between at least one first spatio-temporal position coordinate corresponding to a first person of the every two persons in the spatio-temporal coordinate system and at least one second spatio-temporal position coordinate corresponding to a second person of the every two persons in the spatio-temporal coordinate system;

determine a first number of first spatio-temporal position coordinates corresponding to spatial distances less than or equal to a distance threshold, and a second number of second spatio-temporal position coordinates corresponding to spatial distances less than or equal to the distance threshold;

determine a first ratio of the first number to a total number of first spatio-temporal position coordinates, and a second ratio of the second number to a total number of second spatio-temporal position coordinates; and

determine a maximum value of the first ratio and the second ratio as the similarity between the two persons.

In a possible implementation, the first determination module is further configured to:

perform the person detection on the video images to obtain person images including detection information, the person detection including at least one of face detection and body detection, wherein in a case where the person detection includes the face detection, the detection information includes face information; and in a case where the person detection includes the body detection, the detection information includes body information; and determine, according to the person images, the image set corresponding to the at least one person among the plurality of persons.

In a possible implementation, the first determination module is further configured to:

cluster the person images including the face information to obtain a face clustering result, the face clustering result including at least one face identity for the person images including the face information;

cluster the person images including the body information to obtain a body clustering result, the body clustering result including at least one body identity for the person images including the body information; and

determine, according to the face clustering result and the body clustering result, the image set corresponding to the at least one person among the plurality of persons.

In a possible implementation, the first determination module is further configured to:

determine corresponding relationships between face identities and body identities in at least one person image including the face information and the body information; and

obtain, according to a first corresponding relationship in the corresponding relationships, person images including the face information and/or the body information in the first corresponding relationship from the person images to form an image set corresponding to one person.

In a possible implementation, the first determination module is further configured to:

obtain face identities corresponding to the face information and body identities corresponding to the body information in the person images including the face information and the body information;

group the person images including the face information and the body information according to body identities to which the person images correspond, to obtain at least one body image group, person images in the same body image group having the same body identity; and

determine, for a first body image group in the body image groups, face identities respectively corresponding to at least one person image in the first body image group, and determine, according to the number of person images corresponding to at least one face identity in the first body image group, corresponding relationships between face identities and body identities in the person images in the first body image group.

In a possible implementation, the first determination module is further configured to:

obtain face identities corresponding to the face information and body identities corresponding to the body information in the person images including the face information and the body information;

group the person images including the face information and the body information according to face identities to which the person images correspond, to obtain at least one face image group, person images in the same face image group having the same face identity; and

determine, for a first face image group in the face image groups, body identities respectively corresponding to at least one person image in the first face image group, and determine, according to the number of person images corresponding to at least one body identity in the first face image group, corresponding relationships between face identities and body identities in the person images in the first face image group.

In a possible implementation, the first determination module is further configured to:

determine, for person images including the face information and not belonging to the image set, an image set corresponding to at least one person according to face identities of the person images.

In a possible implementation, the apparatus further comprises:

a fifth determination module, configured to determine a marketing plan for the companions according to the companions among the plurality of persons; and/or, determine an abnormal person among the companions.

According to one aspect of the present disclosure, there is provided a system for detecting companions, comprising a plurality of image capture devices disposed in different areas, and a processing device, wherein

the plurality of image capture devices are configured to capture video images, and send the video images to the processing device;

the processing device is configured to perform person detection on the video images, to determine, according to an obtained person detection result, an image set corresponding to at least one person among a plurality of persons, the image set including person images;

the processing device is further configured to determine track information of the at least one person according to position information of the plurality of image capture devices, the image set corresponding to the at least one person, and time for capturing the person images; and

the processing device is further configured to determine companions among the plurality of persons according to track information of the plurality of persons.

In a possible implementation, the processing device is integrated in the image capture devices.

According to one aspect of the present disclosure, there is provided an electronic device, comprising:

a processor; and

a memory configured to store processor executable instructions,

wherein the processor is configured to invoke the instructions stored in the memory, to execute the above method.

According to one aspect of the present disclosure, there is provided a computer-readable storage medium having computer program instructions stored thereon, wherein the computer program instructions, when executed by a processor, implement the above method.

According to one aspect of the present disclosure, there is provided a computer program, comprising computer-readable codes, wherein when the computer-readable codes run in an electronic device, a processor in the electronic device executes the above method.

In this way, person detection is performed on video images captured by a plurality of image capture devices deployed in different areas during a preset time period; an image set including person images and corresponding to at least one person among a plurality of persons may be determined according to a person detection result; track information of the at least one person may be determined according to position information of the plurality of image capture devices, the image set corresponding to the at least one person and time for capturing the person images; and the companions among the plurality of persons may be determined according to the track information of the plurality of persons. According to the method, apparatus and system for detecting companions, the electronic device and the storage medium provided by the present disclosure, based on the position information and capturing time of the images corresponding to the at least one person and captured by the plurality of image capture devices deployed in the different areas during the preset time period, the track information of the at least one person may be established, thereby determining the companions from the plurality of persons according to the track information of the at least one person. Since the track information can better reflect the dynamic state of the at least one person, determining the companions based on the track information can improve the accuracy of detection on the companions.

It will be appreciated that the above general descriptions and detailed descriptions below are only exemplary and explanatory and not intended to limit the present disclosure. Other features and aspects of the present disclosure will be apparent according to the following detailed description made on the exemplary embodiments with reference to the accompanying drawings.

### BRIEF DESCRIPTION OF THE DRAWINGS

The accompanying drawings, which are incorporated in and constitute a part of the present description, illustrate embodiments consistent with the present disclosure and serve to explain the technical solutions of the present disclosure together with the description.

FIG. 1 illustrates a flowchart of a method for detecting companions according to an embodiment of the present disclosure.

FIG. 2 illustrates a block diagram of an apparatus for detecting companions according to an embodiment of the present disclosure.

FIG. 3 illustrates a block diagram of an electronic device 800 according to an embodiment of the present disclosure.

FIG. 4 illustrates a block diagram of an electronic device 1900 according to an embodiment of the present disclosure.

### DETAILED DESCRIPTION

Various exemplary embodiments, features and aspects of the present disclosure will be described below in detail with reference to the accompanying drawings. Same reference numbers in the accompanying drawings indicate same or similar components. Although various aspects of the embodiments are illustrated in the accompanying drawings, the accompanying drawings are unnecessarily drawn by scale unless specified otherwise.

As used herein, the word “exemplary” means “serving as an example, instance, or illustration”. Any embodiment described herein as “exemplary” is not to be construed as necessarily preferred or advantageous over other embodiments.

The term “and/or” herein is only an association relationship for describing associated objects, and represents that three relationships may exist, for example, A and/or B may represent that: A exists alone, both A and B exist, and B exists alone. In addition, the term “at least one” herein represents any one of a plurality of elements or any combination of at least two elements of the plurality of elements, for example, including at least one of A, B and C may represent including any one or more elements selected from a set formed by A, B and C.

Besides, in order to better describe the present disclosure, many specific details are presented in the following detailed description. It will be appreciated by those skilled in the art that the present disclosure may still be implemented even without some specific details. In some examples, methods, means, components and circuits well-known to those skilled in the art are not described in detail, to highlight the subject of the present disclosure.

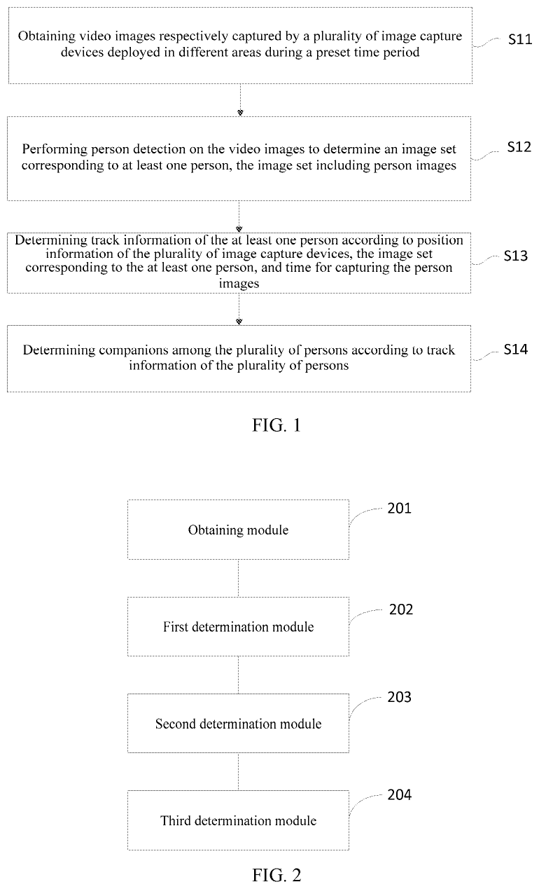

FIG. 1 illustrates a flowchart of a method for detecting companions according to an embodiment of the present disclosure. The object association method may be executed by electronic devices such as a terminal device or a server. The terminal device may be User Equipment (UE), a mobile device, a user terminal, a terminal, a cell phone, a cordless phone, a Personal Digital Assistant (PDA), a handheld device, a computing device, a vehicle-mounted device, a wearable device, etc. The object association method may be implemented by enabling the processor to invoke the computer-readable instruction stored in the memory. Or, the object association method may be executed by the server.

As shown in FIG. 1, the object association method may include:

In step S11, video images respectively captured by a plurality of image capture devices deployed in different areas during a preset time period are obtained.

For example, the image capture devices may be deployed in a plurality of different areas, and the video images of the areas may be captured by the plurality of image capture devices. Thereafter, the video images captured by the plurality of image capture devices during the preset time period may be obtained from the captured video images. The preset time period is one preset time period or a plurality of preset time periods, and a length of each time period may be set as required, which is not limited in the present disclosure. For instance, in a case where the preset time period includes one time period, this time period may be set as 5 mins, and then a plurality of video images captured by the plurality of image capture devices during 5 mins may be obtained. For instance, video streams captured by each image capture device during 5 mins are sampled. For example, a preset time interval (for example, the preset time interval is 1 s) is used for analysis and frame extraction to obtain the plurality of video images.

It is to be noted that, in the image capture devices deployed in the plurality of different areas, areas that can be captured by every two image capture devices may be partially or completely different. The case where the areas that can be captured by the two image capture devices are partially different means that video images captured by the two image capture devices at the same moment partially overlap.

In step S12, person detection is performed on the video images, to determine, according to an obtained person detection result, an image set corresponding to at least one person among a plurality of persons, the image set including person images.

For example, the person detection is used to detect persons in the video images. In the embodiment of the application, the person detection may be used to detect video images having face information and/or body information, and obtain person images having the face information, or the body information, or both the face information and the body information from the video images according to the face information and/or the body information. Then, the image set corresponding to at least one person among a plurality of persons is determined with the person images, wherein the image set corresponding to each person may include at least one person image.

In step S13, track information of the at least one person is determined according to position information of the plurality of image capture devices, the image set corresponding to the at least one person, and time for capturing the person images.

For example, the position information of the image capture devices may serve as second position information of the captured video images, the second position information of the video images may serve as second position information of corresponding person images, and time for capturing the video images may serve as time for capturing the corresponding person images. For each person, track information of the person may be determined according to second position information of each person image in an image set corresponding to the person, first position information of the person in each person image, and time for capturing the person images.

For example, for the image set corresponding to each person, a spatio-temporal position coordinate of the person corresponding to the image set may be determined according to the second position information and capturing time of the person images in the image set. The spatio-temporal position coordinate refers to a point coordinate in a Three-Dimensional (3D) spatio-temporal coordinate system. In the embodiment of the application, each point in the 3D spatio-temporal coordinate system may be used to reflect a geographical position where the person is located and time for capturing video images of the person. For instance, the geographical position where the person is located, i.e., the position information of the person, may be denoted by an x-axis and a y-axis, and the time for capturing the video images of the person may be denoted by a z-axis. With a single person as an example, track information of the person may be established according to spatio-temporal position coordinates corresponding to a plurality of person images included in an image set of the single person. Considering that the plurality of person images are obtained from a video sequence in a sampling manner, the track information of the single person may be denoted as a point group consisting of the spatio-temporal position coordinates, and each point in the point group is a discrete point in the spatio-temporal coordinate system.

In step S14, companions among the plurality of persons are determined according to track information of the plurality of persons.

For example, upon determination of the track information of the at least one person among the plurality of persons, the companions among the plurality of persons may be determined according to the track information. For instance, at least two persons having similar track information may be determined as the companions, or, the track information of at least one person may be clustered, and it is determined that each group of clustered persons respectively corresponds to one group of companions.

For instance, customer A and customer B come to a 4S store at 3 p.m., stay for 15 mins at the reception desk and leave for the XXF6-model vehicle simultaneously; the customer A stays for 10 mins at the XXF6-model vehicle and then heads for the XXF7-model vehicle; the customer B stays for 13 mins at the XXF6-model vehicle and heads for the XXF7-model vehicle; and both the customer A and the customer B leave the 4S store at 4 p.m.

After person detection is performed on video images captured by image capture devices respectively deployed in an area where the reception desk is located, an area where the XXF6-model vehicle is located and an area where the XXF7-model vehicle is located, a plurality of person images of the customer A and the customer B are respectively obtained. An image set 1 composed of person images of the customer A, and an image set 2 composed of person images of the customer B may be respectively obtained according to the plurality of person images. With the image set 1 composed of the person images of the customer A as an example, track information 1 of the customer A may be obtained according to capturing time of a video image corresponding to at least one person image in the image set 1, a position where an image capture device for capturing the video image is located (i.e., second position information), and first position information of the customer A in the at least one person image. Likewise, track information 2 of the customer B may be obtained according to the image set 2 composed of the person images of the customer B. As the customer A and the customer B simultaneously arrive at the area where the reception desk is located, then appear in two same areas, the time for appearing in the two same areas/leaving the two same areas being the same or similar, and finally leave the last visited area simultaneously, it may be determined that the customer A and the customer B are the companions based on the track information 1 and the track information 2.

Based on the position information and capturing time of the images corresponding to the at least one person and captured by the plurality of image capture devices deployed in different areas during the preset time period, the track information of the at least one person may be established, thereby determining the companions from the plurality of persons according to the track information of the at least one person. Since the track information can better reflect the dynamic state of each person, determining the companions based on the track information can improve the accuracy of detection on the companions.

In a possible implementation, performing the person detection on the video images, to determine, according to the obtained person detection result, the image set corresponding to the at least one person among the plurality of persons may include:

performing the person detection on the video images to obtain person images including detection information, the person detection including at least one of face detection and body detection, wherein in a case where the person detection includes the face detection, the detection information includes face information; and in a case where the person detection includes the body detection, the detection information includes body information; and

determining the image set corresponding to the at least one person among the plurality of persons according to the person images.

For example, the face detection may be performed on the video images; and upon detection of the face information, an area including the face information in each video image is framed and extracted in the form of a rectangular frame and the like to serve as the person image, i.e., the video image includes the face information; and/or, the body detection may be performed on the video images; and upon the detection of the body information, an area including the body information in each video image is framed and extracted in the form of the rectangular frame and the like to serve as the person image. The body information may include the face information, which also means that each person image obtained in the manner of extracting the area with the body information may include the body information, or both the face information and the body information.

It is to be noted that the process of obtaining the person images may include but not limited to the above exemplified cases. For example, in the process of extracting the person images from the video images, the areas including the face information and/or the body information, etc. may also be extracted in other manners.

By means of the face information and/or the body information included in the person images, the person images may be classified into sets according to persons to which the person images correspond, to obtain the image set for at least one person among a plurality of persons, i.e., the person images corresponding to each person serve as one image set. In this way, after the person images including the face information and/or the body information are obtained, the image sets respectively corresponding to each person are established according to the person images. For the image set corresponding to each person, the track information of the person may be determined, i.e., the track information of the person may be fitted according to the person images in the image set; and therefore, according to the image sets respectively corresponding to the plurality of persons, the track information of the plurality of persons are respectively fitted.

In a possible implementation, determining the track information of the at least one person according to the position information of the plurality of image capture devices, the image set corresponding to the at least one person and the time for capturing the person images may include:

for at least one person image in the image set corresponding to the at least one person, determining first position information of a target person in the person image in a video image corresponding to the person image;

determining a spatial position coordinate of the target person in a spatial coordinate system according to the first position information and second position information, the second position information being position information of an image capture device for capturing the video image corresponding to the person image;

obtaining a spatio-temporal position coordinate of the target person in a spatio-temporal coordinate system according to the spatial position coordinate and time for capturing the video image corresponding to the person image; and

obtaining the track information of the at least one person in the spatio-temporal coordinate system according to spatio-temporal position coordinates of the plurality of persons.

For example, for at least one person image in each image set, the first position information of the person corresponding to the image set in the person image may be recognized; and then, according to the first position information of the person in the person image and the second position information on where an image capture device for capturing the video image corresponding to the person image is located, the corresponding spatial position coordinate of the person in the spatial coordinate system is determined. The point in the spatial coordinate system may be used to denote geographical position information on where the person is actually located, and may be, for example, expressed as (x,y). In combination with the time t for capturing the video image corresponding to the person image, the point for denoting the person in the spatio-temporal coordinate system may be obtained, and may be, for example, expressed as the spatio-temporal position coordinate (x,y,t). Likewise, for the same image set, the spatio-temporal position coordinate of at least one person image in the image set may be obtained to form the track information of the person corresponding to the same image set. The track information may be expressed as a point group composed of a plurality of spatio-temporal position coordinates. In the embodiment of the application, as the person images are obtained from the sampled video images, the point group may be a set composed of discrete points. In the similar implementation, the point group corresponding to each image set, i.e., the track information of the person corresponding to each image set, may be obtained.

As the track information of each person may reflect a relationship between the position where the person is located and the time, and the companions in the embodiment of the application often refer to two and even more persons having the similar or same movement trends, at least one group of companions may be determined more accurately from the plurality of persons via the track information, and the accuracy of detection on the companions may be improved.

In a possible implementation, determining the companions among the plurality of persons according to the track information of the plurality of persons may include:

clustering the track information of the plurality of persons to obtain at least one cluster set; and

determining persons respectively corresponding to a plurality of groups of track information belonging to the same cluster set as a group of companions.

For example, the obtained track information of the plurality of persons may be clustered to obtain a clustering result, where the clustering result refers to that the track information of the plurality of persons are grouped into at least one cluster set in a clustering manner. Each cluster set at least includes the track information of one person. In an implementation of the embodiment of the application, the persons corresponding to the track information belonging to the same cluster set may be determined as one group of companions. There are no limits made on the manner for clustering the track information in the present disclosure.

In this way, as the track information may indicate the relationship between at least one position where the person is located in a movement process and the time, by clustering the plurality of persons with the track information, a group of persons having more similar movement processes may be obtained; and such a group of persons are the group of companions defined in the embodiment of the application, and thus the accuracy of detection on the companions may be improved.

In a possible implementation, the track information of the at least one person includes the point group in the spatio-temporal coordinate system. Determining the companions among the plurality of persons according to the track information of the plurality of persons may include:

determining similarity for point groups corresponding to every two persons in the spatio-temporal coordinate system in the track information of the plurality of persons;

determining a plurality of person pairs based on a relationship between the similarity and a first similarity threshold, each person pair including two persons, and the similarity for each person pair having a value greater than the first similarity threshold; and

determining at least one group of companions according to the plurality of person pairs.

For example, according to spatio-temporal position coordinates of point groups corresponding to every two persons in the spatio-temporal coordinate system, the similarity between the point groups corresponding to the two persons in the spatio-temporal coordinate system may be determined. In a case where the similarity between the point groups corresponding to the two persons in the spatio-temporal coordinate system is greater than or equal to the first similarity threshold, the two persons may be determined as one person pair, wherein the similarity threshold is a preset value for determining whether two persons are the companions. The first similarity threshold may be a preset value for primarily determining whether two persons are the companions, and the second similarity threshold in the following implementation may be a preset value for secondarily determining whether two persons are the companions, wherein the second similarity threshold is greater than the first similarity threshold. The values of both the first similarity threshold and the second similarity threshold may be determined as required, and there are no limits made on the values of the first similarity threshold and the second similarity threshold herein in the present disclosure. For every two persons among the plurality of persons, whether the two persons may form a person pair may be determined in the above manner; and then, a plurality of person pairs may be determined from the plurality of persons, and according to repeat conditions of the persons included in the plurality of person pairs, at least one group of companions are determined from the plurality of person pairs.

For example: a plurality of persons A, B, C, D, E and F form a plurality of person pairs, and the plurality of person pairs are AB, AC, CD and EF respectively. Since at least two person pairs in AB, AC and CD have the person appearing repeatedly, for instance, A exists in both AB and AC, the persons A, B, C and D form one group of companions, and the persons E and F form one group of companions.

Therefore, by determining the similarity between the point groups of two persons in the spatial coordinate system, whether the two persons may form the companions, i.e., whether the two persons may form the person pair, may be determined. Through the same reasoning, a plurality of person pairs may be determined from the plurality of persons, and then according to whether the plurality of person pairs have the repeat, i.e., whether the plurality of person pairs have the same person, at least one group of companions may be determined from the plurality of person pairs.

In a possible implementation, determining the similarity for the point groups corresponding to every two persons in the spatio-temporal coordinate system in the track information of the plurality of persons may include:

determining a spatial distance between at least one first spatio-temporal position coordinate corresponding to a first person of the every two persons in the spatio-temporal coordinate system and at least one second spatio-temporal position coordinate corresponding to a second person of the every two persons in the spatio-temporal coordinate system;

determining a first number of first spatio-temporal position coordinates corresponding to spatial distances less than or equal to a distance threshold, and a second number of second spatio-temporal position coordinates corresponding to spatial distances less than or equal to the distance threshold;

determining a first ratio of the first number to the total number of first spatio-temporal position coordinates, and a second ratio of the second number to the total number of second spatio-temporal position coordinates; and

determining a maximum value of the first ratio and the second ratio as the similarity between the two persons.

For example, two persons, i.e., the first person and the second person, may be determined from a plurality of persons at random or according to a certain rule. Then, each spatio-temporal position coordinate of the point group corresponding to the first person in the spatio-temporal coordinate system is determined as the first spatio-temporal position coordinate, and each spatio-temporal position coordinate of the point group corresponding to the second person in the spatio-temporal coordinate system is determined as the second spatio-temporal position coordinate. The spatial distance between each first spatio-temporal position coordinate and each second spatio-temporal position coordinate is determined, i.e., with a first spatio-temporal position as a reference, the spatial distance to each second spatio-temporal position coordinate is respectively calculated, and the above operation is performed on each first spatio-temporal position, such that the calculated spatial distance to each second spatio-temporal position coordinate may be obtained for each first spatio-temporal position coordinate. Assume that the point group of the first person in the spatio-temporal coordinate system includes a first spatio-temporal position coordinates, and the point group of the second person in the spatio-temporal coordinate system includes b second spatio-temporal position coordinates, then a*b spatio-temporal distances may be determined in total. There are no limits made on the manner for calculating the spatial distance in the present disclosure.

Each first spatio-temporal position coordinate of the first person respectively corresponds to b spatio-temporal distances. With one first spatio-temporal position coordinate as an example, in a case where one spatio-temporal distance determined based on the first spatio-temporal position coordinate is less than or equal to the distance threshold (the distance threshold may be a preset value and may be set as required, and there are no limits made on the value of the distance threshold), it may be determined that the spatio-temporal distance corresponding to the first spatio-temporal position coordinate is less than or equal to the distance threshold. In the above manner, the first number c of first spatio-temporal position coordinates that are less than or equal to the distance threshold in spatio-temporal distances corresponding to the a first spatio-temporal position coordinates of the first person is respectively determined, where c is less than or equal to the total number of first spatio-temporal position coordinates of the first person. Likewise, the second number d of second spatio-temporal position coordinates that are less than or equal to the distance threshold (preset value) in spatio-temporal distances corresponding to the b second spatio-temporal position coordinates of the second person is determined, where d is less than or equal to the total number of first spatio-temporal position coordinates of the second person. Based on the above, it may be determined that the first ratio corresponding to the first person is: c/a, and the second ratio corresponding to the second person is d/b; and then, the maximum value in the first ratio and the second ratio is determined as the similarity between the first person and the second person. That is, when c/a is greater than d/b, it may be determined that c/a is the similarity between the first person and the second person; and when c/a is less than d/b, it may be determined that d/b is the similarity between the first person and the second person. It is to be noted that in a case where the first ratio is the same as the second ratio, the first ratio and/or the second ratio may be determined as the similarity between the first person and the second person.

In this way, for every two persons among the plurality of persons, the similarity may be determined by using the above method, thereby obtaining the similarity between the track information of the every two persons.

In a possible implementation, determining the at least one group of companions according to the plurality of person pairs may include:

establishing a companion set according to a first person pair in the plurality of person pairs;

determining an associated person pair from at least one second person pair, other than the person pair included in the companion set, in the plurality of person pairs, the associated person pair including at least one person in the companion set;

adding the associated person pair to the companion set; and

determining persons in the companion set as a group of companions.

For example, one person pair may be randomly selected from the plurality of person pairs to serve as the first person pair, and two persons included in the first person pair are taken as two persons in the companion set to establish the companion set, or, the companion set is established according to a certain rule that, for instance, the person pair of the high similarity in the plurality of person pairs may be selected as the first person pair to establish the companion set. Thereafter, the person pairs not completely belonging to the companion set are determined as the second person pairs. The second person pairs may include the person in the companion set or not include the person in the companion set. In the second person pairs, the person pair including any person in the companion set is taken as the associated person pair, and added to the companion set, till all second person pairs are filtered. Therefore, the determination on one group of companions may be implemented based on the first person pair. It is to be noted that the person pair not belonging to the above group of companions in the second person pairs, similar implementations may be used to reestablish at least one group of companions.

For example, in the above case, the person pair AB in the plurality of person pairs AB, AC, CD and EF is used as the first person pair to establish the companion set, and at this time, the companion set includes the person A and the person B. The rest of the plurality of person pairs are determined as the second person pairs (i.e., AC, CD and EF), wherein the person pair AC in the second person pairs includes the person A, so the person pair AC as the associated person pair is added to the companion set; and at this time, the companion set includes the person A, the person B and the person C. It is determined that the person pair CD in the remaining second person pairs includes the person C, so the person pair CD as the associated person pair is added to the companion set. At this time, the companion set includes the person A, the person B, the person C and the person D. Now, the remaining second person pair EF does not include any person in the companion set, and consequently, the person A, the person B, the person C and the person D in the companion set are determined as a group of companions. Likewise, the person pair EF may be determined as another group of companions. In this way, two groups of companions may be obtained from the plurality of person pairs, i.e., according to the repeat of the person included in the plurality of person pairs, at least one group of companions may be obtained from the plurality of person pairs.

In marketing scenarios of the stores, it is possible that the same staff member is in the company of a plurality of groups of persons, and in this case, there are many persons forming the person pairs with the staff member; or, in particular places, it is possible that a suspicious person like a thief follow the persons for stealing, and in this case, the suspicious person like the thief is also classified into the plurality of person pairs. The staff member refers to a person who may provide services for each person in the marketing scenarios of the stores, such as a salesperson. In view of the purpose of grouping the companions, a targeted marketing plan suitable for one group of persons may be determined for the companions. As a result, the salesperson or other persons with no purchase intentions are generally not taken into consideration. In order to solve the problem that one group of companions include the person not belonging to the companions due to misrecognition, in a possible implementation, adding the associated person pair to the companion set may include:

determining the number of person pairs including a first person in the associated person pair; and

adding the associated person pair to the companion set in a case where the number of person pairs including the first person is less than a number-of-person-pairs threshold.

For example, any person in the associated person pair may be determined as the first person, and the number of person pairs formed by the first person may be determined. For instance, the person A in the associated person pair AC respectively forms the person pairs AB and AC with the person B and the person C, such that there are two person pairs including the person A. When the number of person pairs including any person in the associated person pair is less than the number-of-person-pairs threshold (which is a preset value and may be set as required; and there are no limits made on the value of the number-of-person-pairs threshold herein in the present disclosure), it may be determined that the associated person pair may be added to the companion set to form a group of companions with the person in the companion set. When the number of person pairs including any person in the associated person pair is greater than the number-of-person-pairs threshold, it may be determined that the person is the staff member; and the person pair is not added to the companion set to prevent other groups of companions from merging with this group of companions due to the staff member.

Considering that a group of companions including more persons may be obtained by using the technical solutions provided by the embodiment of the application, in order to improve the accuracy of determining the group of companions, the persons included in one group of companions may be filtered in a case where the one group of companions include a large number of persons, thereby removing one or more persons less likely to become the companions in the group of companions. In a possible implementation, after the at least one group of companions are determined according to the plurality of person pairs, the method may further include:

in a case where the number of persons included in the group of companions is greater than a first number threshold, at least one person pair having a value of the similarity greater than a second similarity threshold in the plurality of person pairs is determined as a group of companions, such that the number of persons included in the group of companions is less than the first number threshold, the second similarity threshold being greater than the first similarity threshold.

For example, the first number threshold is the preset largest number of persons in the group of companions. The first number threshold may be set as required, and there are no limits made on the value of the first number threshold in the present disclosure. When the number of persons included in the group of companions is greater than the first number threshold, at least one person pair having the corresponding similarity greater than the second similarity threshold in a plurality of person pairs in the companions may be determined as a group of companions, such that while the number of companions meets the requirement, the accuracy of detection on the companions may be improved. The second similarity threshold is a preset value greater than the first similarity threshold, and may be set as required; and there are no limits made on the value of the second similarity threshold in the present disclosure. Therefore, based on the obtained group of companions, the person pair having the similarity less than or equal to the second similarity threshold may be filtered in a secondary filtering manner, thereby reducing the number of persons included in the group of companions.

In an implementation, determining the image set corresponding to the at least one person among the plurality of persons according to the person images may include:

clustering the person images including the face information to obtain a face clustering result, the face clustering result including at least one face identity for the person images including the face information;

clustering the person images including the body information to obtain a body clustering result, the body clustering result including at least one body identity for the person images including the body information; and

determining, according to the face clustering result and the body clustering result, the image set corresponding to the at least one person among the plurality of persons.

For example, person images including the face information may be determined from the person images, and person images including the body information may be determined from the person images. The person images including the face information may be clustered, for instance, a face feature in at least one person image may be extracted, and face clustering is performed through the extracted face feature to obtain the face clustering result. Exemplarily, a trained model, such as a pre-trained neutral network model for the face clustering, may be used to perform the face clustering on the person images including the face information; the person images including the face information are clustered into a plurality of categories; each category is assigned with one face identity, such that each person image including the face information has the face identity; and the person images including the face information that belong to the same category have the same face identity, and the person images including the face information that belong to different categories have different face identities, thereby obtaining the face clustering result. There are no limits made on the specific manner of the face clustering in the present disclosure.

Likewise, the person images including the body information may be clustered, for instance, a body feature in at least one person image may be extracted, and clustering is performed through the extracted body feature to obtain the body clustering result. Exemplarily, a trained model, such as a pre-trained neutral network model for the body clustering, may be used to perform the body clustering on the person images including the body information; the person images including the body information are clustered into a plurality of categories; each category is assigned with one body identity, such that each person image including the body information has the body identity; and the person images including the body information that belong to the same category have the same body identity, and the person images including the body information that belong to different categories have different body identities, thereby obtaining the body clustering result. There are no limits made on the specific manner of the body clustering in the present disclosure.

The person images including both the face information and the body information are subjected to the face clustering to obtain the face identities, and subjected to the body clustering to obtain the body identities. For the person images including both the face information and the body information, the face identities may be associated with the body identities; and according to the associated face identities and body identities, the person images (the person images including the face information and the person images including the body information) corresponding to the same person may be determined, thereby obtaining the image set corresponding to the person.

In a possible implementation, before the person images including the body information are clustered, the person images may be filtered according to the integrity of the body information included in the person images; and the filtered person images are clustered to obtain the body clustering result, thereby removing the person images with insufficient accuracy and no reference significance, and improving the clustering accuracy. For instance, body key point information may be preset, and body key point information in the person images may be detected; and whether the body information in the person images is integrate may be determined according to a degree of matching between the detected body key point information and the preset body key point information, and the person images in which the body information is not integrate are deleted so as to filter the person images. Exemplarily, a pre-trained neutral network for detecting the integrity of the body information may be used to filter the person images, which will not be repeated here in the present disclosure.

In a possible implementation, determining, according to the face clustering result and the body clustering result, the image set corresponding to the at least one person among the plurality of persons may include:

determining corresponding relationships between face identities and body identities in at least one person image including the face information and the body information;

obtaining, according to a first corresponding relationship in the corresponding relationships, person images including the face information and/or the body information in the first corresponding relationship from the person images to form an image set corresponding to one person.

The above first corresponding relationship may be randomly selected from all corresponding relationships, or is selected according to a certain rule. For example, it may be determined that the person images including both the face information and the body information not only participate in the face clustering to obtain the face identities, but also participated in the body clustering to obtain the body identities, i.e., the person images are provided with both the face identities and the body identities.

By means of the person images including the face information and the body information, the body identities and face identities corresponding to the same person may be associated together; and through the corresponding relationships between the body identities and the face identities, three categories of person images corresponding to the same person are obtained, namely, the person images including only the body information, the person images including only the face information, and the person images including both the body information and the face information. The above three categories of obtained person images form the image set corresponding to the person. Then, according to geographical position information on where the person in the image set is actually located and capturing time, the track information of the person is established.

For each corresponding relationship, with the adoption of the above method, the corresponding image set of the person corresponding to each corresponding relationship may be determined. In this way, with mutual complementation between the face clustering result and the body clustering result, the person images in the image set corresponding to the person may be increased, and more track information is determined according to the increased person images.

As the body clustering accuracy is lower than the face clustering accuracy, it is possible that a plurality of person images corresponding to the same body identity correspond to a plurality of face identities. For instance, there are 20 person images including both the face information and the body information that correspond to the body identity BID1, but the 20 person images correspond to three face identities: FID1, FID2 and FID3. In this case, the face identity corresponding to the same person with the body identity BID1 need to be determined from the three face identities.

In a possible implementation, determining the corresponding relationships between the face identities and the body identities in at least one person image including the face information and the body information may include:

obtaining face identities corresponding to the face information and body identities corresponding to the body information in the person images including the face information and the body information;

grouping the person images including the face information and the body information according to body identities to which the person images correspond, to obtain at least one body image group, person images in the same body image group having the same body identity; and

determining, for a first body image group in the body image groups, face identities respectively corresponding to at least one person image in the first face image group, and determining, according to the number of person images corresponding to at least one face identity in the first face image group, corresponding relationships between face identities and body identities in the person images of the first face image group.

For example, the person images including the face information and the body information may be determined, and the face identities and the body identities of the person images are obtained. The person images are grouped according to the body identities to which the person images correspond. For instance, there are 50 person images including the face information and the body information, among which 10 person images correspond to the body identity BID1 and the 10 person images may form the body image group 1, 30 person images correspond to the body identity BID2 and the 30 person images may form the body image group 2, and 10 person images correspond to the body identity BID3 and the 10 person images may form the body image group 3.

The first body image group may be one body image group randomly selected from all body image groups, or may be selected according to a certain rule. For the first body image group, face identities corresponding to at least one person image in the first body image group may be determined, the number of person images corresponding to the same face identity is determined, and according to the number of person images corresponding to at least one face identity in the first body image group, corresponding relationships between face identities and body identities of the person images in the first body image group are determined.

For instance, it may be determined that the face identity corresponding to the largest number of person images in the first body image group corresponds to the body identity, or, it may be determined that the face identity having a proportion occupied by the number of corresponding person images of the first body image group in the first body image group higher than a threshold corresponds to the body identity.

With the body image group 2 in the above case as an example, upon the determination that 20 person images of the 30 person images in the body image group 2 correspond to the identity FID1, four person images correspond to the identity FID2 and six person images correspond to the identity FID2, it may be determined that the face identity FID1 is associated with the body identity BID2. Or, assume that the threshold is set as 50%, the FID1 accounts for 67%, the FID2 accounts for 13%, and the FID1 accounts for 20%; then it may be determined that the face identity FID1 is associated with the body identity BID2.

For each body image group, the corresponding relationship between the face identity and the body identity in each person image including the face information and the body information may be determined by using the above method. In this way, through mutual correction between the face clustering result and the body clustering result, the clustering accuracy may be improved, and thus the accuracy of the image set corresponding to the person and obtained according to the body clustering result and the face clustering result is improved; and through the more accurate image set, the more accurate track information may be determined.

In a possible implementation, determining the corresponding relationships between the face identities and the body identities in at least one person image including the face information and the body information may include:

obtaining face identities corresponding to the face information and body identities corresponding to the body information in the person images including the face information and the body information;

grouping second images including the face information and the body information according to face identities to which the second images correspond, to obtain at least one face image group, person images in the same face image group having the same face identity; and

determining, for a first face image group in the face image groups, body identities respectively corresponding to at least one person image in the first face image group, and determining, according to the number of person images corresponding to at least one body identity in the first face image group, corresponding relationships between face identities and body identities in the person images of the first face image group.

For example, the person images including the face information and the body information may be determined, and the face identities and the body identities of the person images are obtained. The person images are grouped according to the face identities to which the person images correspond. For instance, there are 50 person images including the face information and the body information, among which 10 person images correspond to the body identity FID1 and the 10 person images may form the face image group 1, 30 person images correspond to the face identity FID2 and the 30 person images may form the face image group 2, and 10 person images correspond to the face identity FID3 and the 10 person images may form the face image group 3.

The first face image group may be one face image group randomly selected from all face image groups, or may be selected according to a certain rule. For the first face image group, body identity corresponding to at least one person image in the first face image group may be determined, the number of person images corresponding to the same body identity is determined, and according to the number of person images corresponding to each body identity in the first face image group, corresponding relationships between face identities and body identities of the person images in the first body image group are determined.

For instance, it may be determined that the body identity corresponding to the largest number of person images in the first face image group corresponds to the face identity, or, it may be determined that the body identity having a proportion occupied by the number of corresponding person images of the first face image group in the face image group higher than a threshold corresponds to the face identity.

With the face image group 2 in the above case as an example, upon determination that 20 person images of the 30 person images in the face image group 2 correspond to the body identity BID1, four person images correspond to the body identity BID2 and six person images correspond to the body identity BID2, it may be determined that the body identity BID1 is associated with the face identity FID2. Or, assume that the threshold is set as 50%, the BID1 accounts for 67%, the BID2 accounts for 13%, and the BID1 accounts for 20%; and then it may be determined that the body identity BID1 is associated with the face identity FID2.

For each face image group, the corresponding relationship between the face identity and the body identity in each person image including the face information and the body information may be determined by using the above method. In this way, through mutual correction between the face clustering result and the body clustering result, the clustering accuracy may be improved, and thus the accuracy of the image set corresponding to the person and obtained according to the body clustering result and the face clustering result is improved; and through the more accurate image set, the more accurate track information may be determined.

In a possible implementation, determining, according to the face clustering result and the body clustering result, the image set corresponding to the at least one person among the plurality of persons may include:

Determining, for person images including the face information in the image set, the image set corresponding to at least one person according to face identities of the person images.

For example, for person images which include the face feature and do not belong to any image set in the person images, at least one image set may be established for such person images according to face identities to which the person images correspond, second images in established any image set having the same face identity.

In this way, a plurality of image sets may be obtained, and thus all person images are clustered. Then, track information of a corresponding person can be established according to second position information and capturing time of person images in at least one image set, thereby determining at least one group of companions from a plurality of persons according to the track information of the at least one person.

In a possible implementation, after the companions among the plurality of persons are determined according to the track information of the plurality of persons, the method may further include at least one of:

determining a marketing plan for the companions according to the companions among the plurality of persons; and

determining an abnormal person among the companions.

For example, after the companions among the plurality of persons are determined, the group of companions may be led to one staff member for follow-up and service delivery, the marketing plan for the group of companions is formulated according to behavioral data and other information of the group of companions, and statistics on the behavioral data of the group of companions is performed to determine the conversion rate and the like of the order. Or, the abnormal person, such as the thief and the criminal suspect, may further be determined from the group of companions.

It will be appreciated that the method embodiments mentioned in the present disclosure may be combined with each other to form a combined embodiment without departing from the principle and logic, which will not be repeated in the the present disclosure for the sake of simplicity. It will be appreciated by those skilled in the art that in the method of the specific implementation, the specific execution sequence of steps may be determined in terms of the function and possible internal logic.

In addition, the present disclosure further provides an apparatus for detecting companions, an electronic device, a computer-readable storage medium and a program, all of which may be configured to implement any method for detecting the companions provided by the present disclosure. The corresponding technical solutions and descriptions refer to the corresponding descriptions in the method and will not be repeated herein.

FIG. 2 illustrates a block diagram of an apparatus for detecting companions according to an embodiment of the present disclosure. As shown in FIG. 2, the apparatus for detecting companions includes:

an obtaining module 201, configured to obtain video images respectively captured by a plurality of image capture devices deployed in different areas during a preset time period;

a first determination module 202, configured to perform person detection on the video images obtained by the obtaining module 201, to determine, according to an obtained person detection result, an image set corresponding to at least one person among a plurality of persons, the image set including person images;

a second determination module 203, configured to determine track information of the at least one person according to position information of the plurality of image capture devices, the image set corresponding to the at least one person and obtained by the second determination module 202, and time for capturing the person images; and

a third determination module 204, configured to determine companions among the plurality of persons according to track information of the plurality of persons that is obtained by the second determination module 203.

In this way, the person detection is performed on the video images captured by the plurality of image capture devices deployed in different areas during the preset time period; the image set including the person images and corresponding to each person among the plurality of persons may be determined according to the person detection result; the track information of each person may be determined according to the position information of the plurality of image capture devices, the image set corresponding to each person and the time for capturing the person images; and the companions among the plurality of persons may be determined according to the track information of the plurality of persons. According to the apparatus for detecting companions provided by the present disclosure, based on the position information and capturing time of the images corresponding to each person and captured by the plurality of image capture devices deployed in different areas during the preset time period, the track information of each person may be established, thereby determining the companions from the plurality of persons according to the track information of each person. Since the track information can better reflect the dynamic state of each person, determining the companions based on the track information can improve the accuracy of detection on the companions.

In a possible implementation, the second determination module may further be configured to:

determine, for at least one person image in the image set corresponding to the at least one person, first position information of a target person in the person image in a video image corresponding to the person image;

determine a spatial position coordinate of the target person in a spatial coordinate system according to the first position information and second position information, the second position information being position information of an image capture device for capturing the video image corresponding to the person image;

obtain a spatio-temporal position coordinate of the target person in a spatio-temporal coordinate system according to the spatial position coordinate and time for capturing the video image corresponding to the person image; and

obtain the track information of the at least one person in the spatio-temporal coordinate system according to spatio-temporal position coordinates of the plurality of persons.

In a possible implementation, the third determination module may further be configured to:

cluster the track information of the plurality of persons to obtain at least one cluster set; and

determine persons respectively corresponding to a plurality of pieces of track information belonging to the same cluster set as a group of companions.

In a possible implementation, the track information of the at least one person includes a point group in the spatio-temporal coordinate system; and the second determination module may further be configured to:

determine the companions among the plurality of persons according to the track information of the plurality of persons, including:

determine similarity for point groups corresponding to every two persons in the spatio-temporal coordinate system in the track information of the plurality of persons;

determine a plurality of person pairs based on a relationship between the similarity and a first similarity threshold, each person pair including two persons, and the similarity for each person pair having a value greater than the first similarity threshold; and

determine at least one group of companions according to the plurality of person pairs.

In a possible implementation, the second determination module may further be configured to:

establish a companion set according to a first person pair in the plurality of person pairs;

determine an associated person pair from at least one second person pair, other than the person pair included in the companion set, in the plurality of person pairs, the associated person pair including at least one person in the companion set;

add the associated person pair to the companion set; and

determine persons in the companion set as a group of companions.

In a possible implementation, the second determination module may further be configured to:

determine the number of person pairs including a first person in the associated person pairs; and

add the associated person pair to the companion set in a case where the number of person pairs including the first person is less than a number-of-person-pairs threshold.

In a possible implementation, the apparatus may further include:

a fourth determination module, configured to determine, in a case where the number of persons included in the group of companions is greater than a first number threshold, at least one person pair having a value of the similarity greater than a second similarity threshold in the plurality of person pairs as a group of companions, such that the number of persons included in the group of companions is less than the first number threshold, the second similarity threshold being greater than the first similarity threshold.

In a possible implementation, the second determination module may further be configured to:

determine a spatial distance between at least one first spatio-temporal position coordinate corresponding to a first person of the every two persons in the spatio-temporal coordinate system and at least one second spatio-temporal position coordinate corresponding to a second person of the every two persons in the spatio-temporal coordinate system;

determine a first number of first spatio-temporal position coordinates corresponding to spatial distances less than or equal to a distance threshold, and a second number of second spatio-temporal position coordinates corresponding to spatial distances less than or equal to the distance threshold;

determine a first ratio of the first number to the total number of first spatio-temporal position coordinates, and a second ratio of the second number to the total number of second spatio-temporal position coordinates; and

determine a maximum value of the first ratio and the second ratio as the similarity between the two persons.

In a possible implementation, the first determination module may further be configured to:

perform the person detection on the video images to obtain person images including detection information, the person detection including at least one of face detection and body detection, wherein in a case where the person detection includes the face detection, the detection information includes face information; and in a case where the person detection includes the body detection, the detection information includes body information; and

determine, according to the person images, the image set corresponding to the at least one person among the plurality of persons.

In a possible implementation, the first determination module may further be configured to:

cluster the person images including the face information to obtain a face clustering result, the face clustering result including at least one face identity for the person images including the face information;

cluster the person images including the body information to obtain a body clustering result, the body clustering result including at least one body identity for the person images including the body information; and

determine, according to the face clustering result and the body clustering result, the image set corresponding to the at least one person among the plurality of persons.

In a possible implementation, the first determination module may further be configured to:

determine corresponding relationships between face identities and body identities in at least one person image including the face information and the body information; and

obtain, according to a first corresponding relationship in the corresponding relationships, person images including the face information and/or the body information in the first corresponding relationship from the person images to form an image set corresponding to one person.

In a possible implementation, the first determination module is further configured to:

obtain face identities corresponding to the face information and body identities corresponding to the body information in the person images including the face information and the body information;

group the person images including the face information and the body information according to body identities to which the person images correspond, to obtain at least one body image group, person images in the same body image group having the same body identity; and

determine, for a first body image group in the body image groups, face identities respectively corresponding to at least one person images in the first body image group, and determine, according to the number of person images corresponding to at least one face identity in the first body image group, corresponding relationships between face identities and body identities in the person images in the first body image group.

In a possible implementation, the first determination module is further configured to:

obtain face identities corresponding to the face information and body identities corresponding to the body information in the person images including the face information and the body information;

group the person images including the face information and the body information according to face identities to which the person images correspond, to obtain at least one face image group, person images in the same face image group having the same face identity; and

determine, for a first face image group in the face image groups, body identities respectively corresponding to at least one person image in the first face image group, and determine, according to the number of person images corresponding to at least one body identity in the first face image group, corresponding relationships between face identities and body identities in the person images in the first face image group.

In a possible implementation, the first determination module is further configured to:

determine, for person images including the face information and not belonging to the image set, an image set corresponding to at least one person according to face identities of the person images.

In a possible implementation, the apparatus further includes a fifth determination module, configured to perform at least one of:

determine a marketing plan for the companions according to the companions among the plurality of persons; and

determine an abnormal person among the companions.

In some embodiments, functions or included modules of the apparatus provided by the embodiment of the present disclosure may be configured to execute the method described in the above method embodiment; and the specific implementation may refer to the description in the method embodiment, which will not be repeated herein for the sake of simplicity.

An embodiment of the present disclosure provides a system for detecting companions. The system includes a plurality of image capture devices disposed in different areas and a processing device.

The plurality of image capture devices are configured to capture video images, and send the video images to the processing device.

The processing device is configured to perform person detection on the video images, to determine, according to an obtained person detection result, an image set corresponding to at least one person among a plurality of persons, the image set including person images.

The processing device is further configured to determine track information of the at least one person according to position information of the plurality of image capture devices, the image set corresponding to the at least one person, and time for capturing the person images.

The processing device is further configured to determine companions among the plurality of persons according to track information of the plurality of persons.

In a possible implementation, the processing device may be separately deployed, or integrally deployed with the image capture device; for example, the processing device may be integrated into one image capture device, or at least one image capture device is integrated into the processing device, etc.

With the case where the processing device and the image capture devices are separately deployed as an example, the plurality of image capture devices deployed in different areas capture the video images and send the captured video images to the processing device; and the processing device may determine the companions according to the captured video images. For the specific process, refer to the foregoing embodiment, which will not be repeated here in the present disclosure.

It is to be noted that at least two image capture devices of the plurality of image capture devices may be deployed in the same area, or different image capture devices of the plurality of image capture devices are deployed in different areas. In actual deployment, in order to ensure integrity of the video pictures and reduce blind areas, areas photographed by the plurality of image capture devices may at least partially overlap. Certainly, the image capture devices may also be controlled to respectively photograph different areas according to actual needs. Herein, the manner for deploying the plurality of image capture devices is not limited, and may include but not limited to the cases exemplified in the present disclosure.

According to the system for detecting companions provided by the present disclosure, based on the position information and capturing time of the images corresponding to the at least one person and captured by the plurality of image capture devices deployed in the different areas during the preset time period, the track information of the at least one person may be established, thereby determining the companions from the plurality of persons according to the track information of the at least one person. Since the track information can better reflect the dynamic state of the at least one person, determining the companions based on the track information can improve the accuracy of detection on the companions.

An embodiment of the present disclosure further provides a computer-readable storage medium having computer program instructions stored thereon, and the computer program instructions, when executed by a processor, implement the above method. The computer-readable storage medium may be a non-volatile computer-readable storage medium.

An embodiment of the present disclosure further provides an electronic device, which may include: a processor; and a memory, configured to store processor executable instructions, wherein the processor is configured to invoke the instructions stored in the memory, to execute the above method.

An embodiment of the present disclosure further provides a computer program product, which may include computer-readable codes; and when the computer-readable codes run on a device, a processor in the device executes the instructions for implementing the method for detecting companions provided by any of the above embodiments.

An embodiment of the present disclosure further provides another computer program product, for storing computer-readable instructions, which, when executed, cause a computer to execute the operations for detecting the companions provided by any of the above embodiments.

An embodiment of the present disclosure further provides another computer program, which may include computer-readable codes; and when the computer readable codes run in an electronic device, a processor in the electronic device executes the operations for detecting the companions provided by any of the above embodiments.

The electronic device may be provided as a terminal, a server or other types of devices.

Different embodiments of the present disclosure may be combined with each other without departing from the logic. The different embodiments are described with an emphasis, and for contents not described intensively, the descriptions in the other embodiments may be referred to.

In some embodiments of the present disclosure, functions or modules of the apparatus provided by the embodiment of the present disclosure may be configured to execute the method described in the above method embodiment; and the specific implementation and technical effect may refer to the description in the method embodiment, which will not repeated herein for the sake of simplicity.

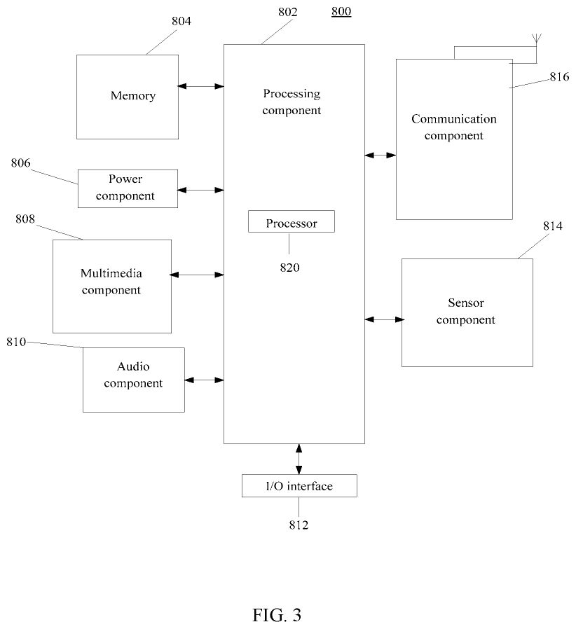

FIG. 3 illustrates a block diagram of an electronic device 800 according to an embodiment of the present disclosure. For example, the electronic device 800 may be a terminal such as a mobile phone, a computer, a digital broadcast terminal, a messaging device, a gaming console, a tablet, a medical device, exercise equipment and a PDA.

Referring to FIG. 3, the electronic device 800 may include one or more of the following components: a processing component 802, a memory 804, a power component 806, a multimedia component 808, an audio component 810, an Input/Output(/) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the steps in the above methods. Moreover, the processing component 802 may include one or more modules for the interaction between the processing component 802 and other components. For instance, the processing component 802 may include a multimedia module for the interaction between the multimedia component 808 and the processing component 802.

The memory 804 is configured to store various types of data to support the operations of the electronic device 800. Examples of such data include instructions for any application or method operated on the electronic device 800, contact data, phonebook data, messages, pictures, videos, etc. The memory may be, for example, a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 806 provides power to various components of the electronic device 800. The power component 806 may include a power management system, one or more power sources, and any other components associated with the generation, management, and distribution of power in the electronic device 800.

The multimedia component 808 includes a screen providing an output interface between the electronic device 800 and the user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. In some embodiments, the multimedia component 808 includes a front camera and/or a rear camera. The front camera and/or the rear camera may receive external multimedia data when the electronic device 800 is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 includes a Microphone (MIC), and the MIC is configured to receive an external audio signal when the electronic device 800 is in the operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 includes one or more sensors configured to provide status assessment in various aspects for the electronic device 800. For instance, the sensor component 814 may detect an on/off status of the electronic device 800 and relative positioning of components, such as a display and small keyboard of the electronic device 800; and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor, configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to be used for wired or wireless communication between the electronic device 800 and another device. The electronic device 800 may access a communication-standard-based wireless network, such as a Wireless Fidelity (WiFi) network, a 2nd-Generation (2G) or 3rd-Generation (3G) network or a combination thereof. In an exemplary embodiment, the communication component 816 receives a broadcast signal or broadcast associated information from an external broadcast management system through a broadcast channel. In an exemplary embodiment, the communication component 816 further includes a Near Field Communication (NFC) module for short-range communication. For example, the NFC module may be implemented based on a Radio Frequency Identification (RFID) technology, an Infrared Data Association (IrDA) technology, an Ultra-WideBand (UWB) technology, a Bluetooth (BT) technology and another technology.

In an exemplary embodiment, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the above method.

In an exemplary embodiment, a non-volatile computer-readable storage medium, such as the memory 804 including an computer program instruction, is further provided; and the computer program instruction may be executed by the processor 820 of the electronic device 800 to implement the above method.

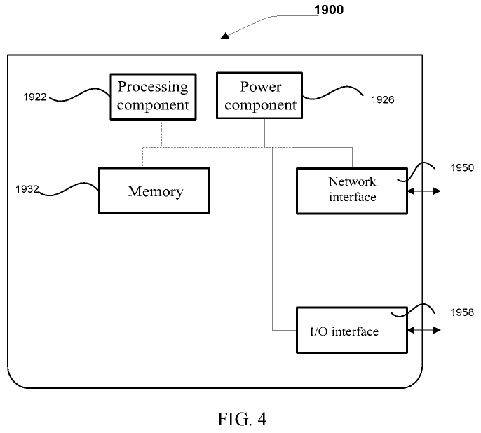

FIG. 4 illustrates a block diagram of an electronic device 1900 according to an embodiment of the present disclosure. For example, the electronic device 1900 may be provided as a server. Referring to FIG. 4, the electronic device 1900 includes a processing component 1922 which further includes one or more processors, and a memory resource represented by a memory 1932 configured to store instructions executable for the processing component 1922, for example, an application program. The application program stored in the memory 1932 may include one or more modules, with each module corresponding to one group of instructions. In addition, the processing component 1922 is configured to execute the instruction to execute the above method.

The electronic device 1900 may further include a power component 1926 configured to execute power management of the electronic device 1900, a wired or wireless network interface 1950 configured to connect the electronic device 1900 to a network, and an I/O interface 1958. The electronic device 1900 may be operated based on an operating system stored in the memory 1932, for example, Windows Server™, Mac OS X™, Unix™, Linux™, FreeBSD™ or the like.

In an exemplary embodiment, there is also provided a non-volatile computer-readable storage medium, such as the memory 1932 including a computer program instruction. The computer program instruction may be executed by the processing component 1922 of the electronic device 1900 to implement the above method.

The present disclosure may be implemented by a system, a method, and/or a computer program product. The computer program product may include a computer readable storage medium having computer readable program instructions for causing a processor to carry out the aspects of the present disclosure stored thereon.

The computer readable storage medium can be a tangible device that can retain and store instructions used by an instruction executing device. The computer readable storage medium may be, but not limited to, e.g., electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein can be downloaded to individual computing/processing devices from a computer readable storage medium or to an external computer or external storage device via network, for example, the Internet, local area network, wide area network and/or wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local area network (LAN) or wide area network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; the electronic circuitry may execute the computer readable program instructions, so as to achieve the aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, can be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer readable program instructions may also be stored in a computer readable storage medium, wherein the instructions cause a computer, a programmable data processing device and/or other devices to function in a particular manner, such that the computer readable storage medium having instructions stored therein comprises a product that includes instructions implementing aspects of the functions/acts specified in one or more blocks in the flowchart and/or block diagram.

The computer readable program instructions may also be loaded onto a computer, other programmable data processing devices, or other devices to have a series of operational steps performed on the computer, other programmable devices or other devices, so as to produce a computer implemented process, such that the instructions executed on the computer, other programmable devices or other devices implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a portion of code, which comprises one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, can be implemented by dedicated hardware-based systems performing the specified functions or acts, or by combinations of dedicated hardware and computer instructions.

The computer program product may be specifically implemented through hardware, software or a combination thereof. In an optional embodiment, the computer program product is specifically embodied as a computer storage medium; and in another optional embodiment, the computer program product is specifically embodied as a software product, such as a Software Development Kit (SDK).

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

1. A method for detecting companions, comprising:
obtaining video images respectively captured by a plurality of image capture devices deployed in different areas during a preset time period;
performing person detection on the video images, to determine, according to an obtained person detection result, an image set corresponding to at least one person among a plurality of persons, the image set including person images;
determining track information of the at least one person according to position information of the plurality of image capture devices, the image set corresponding to the at least one person, and time for capturing the person images; and
determining companions among the plurality of persons according to track information of the plurality of persons.

2. The method according to claim 1, wherein determining the track information of the at least one person according to the position information of the plurality of image capture devices, the image set corresponding to the at least one person, and time for capturing the person images includes:
determining, for at least one person image in the image set corresponding to the at least one person, first position information of a target person in the person image in a video image corresponding to the person image;
determining a spatial position coordinate of the target person in a spatial coordinate system according to the first position information and second position information, the second position information being position information of an image capture device for capturing the video image corresponding to the person image;
obtaining a spatio-temporal position coordinate of the target person in a spatio-temporal coordinate system according to the spatial position coordinate and time for capturing the video image corresponding to the person image; and
obtaining the track information of the at least one person in the spatio-temporal coordinate system according to spatio-temporal position coordinates of the plurality of persons.

3. The method according to claim 1, wherein determining companions among the plurality of persons according to track information of the plurality of persons includes:
clustering the track information of the plurality of persons to obtain at least one cluster set; and
determining persons respectively corresponding to a plurality of pieces of track information belonging to the same cluster set as a group of companions.

4. The method according to claim 2, wherein the track information of the at least one person includes a point group in the spatio-temporal coordinate system; and
determining companions among the plurality of persons according to track information of the plurality of persons includes:
determining similarity for point groups corresponding to every two persons in the spatio-temporal coordinate system in the track information of the plurality of persons;
determining a plurality of person pairs based on a relationship between the similarity and a first similarity threshold, each person pair including two persons, and the similarity for each person pair having a value greater than the first similarity threshold; and
determining at least one group of companions according to the plurality of person pairs.

5. The method according to claim 4, wherein determining at least one group of companions according to the plurality of person pairs includes:
establishing a companion set according to a first person pair in the plurality of person pairs;
determining an associated person pair from at least one second person pair, other than the person pair included in the companion set, in the plurality of person pairs, the associated person pair including at least one person in the companion set;
adding the associated person pair to the companion set; and
determining persons in the companion set as a group of companions.

6. The method according to claim 5, wherein adding the associated person pair to the companion set includes:
determining a number of person pairs including a first person in the associated person pairs; and
adding the associated person pair to the companion set in a case where the number of person pairs including the first person is less than a number-of-person-pairs threshold.

7. The method according to claim 4, after determining the at least one group of companions according to the plurality of person pairs, further comprising:
determining, in a case where the number of persons included in the group of companions is greater than a first number threshold, at least one person pair having a value of the similarity greater than a second similarity threshold in the plurality of person pairs as a group of companions, such that the number of persons included in the group of companions is less than the first number threshold, the second similarity threshold being greater than the first similarity threshold.

8. The method according to claim 4, wherein determining similarity for point groups corresponding to every two persons in the spatio-temporal coordinate system in the track information of the plurality of persons includes:
determining a spatial distance between at least one first spatio-temporal position coordinate corresponding to a first person of the every two persons in the spatio-temporal coordinate system and at least one second spatio-temporal position coordinate corresponding to a second person of the every two persons in the spatio-temporal coordinate system;
determining a first number of first spatio-temporal position coordinates corresponding to spatial distances less than or equal to a distance threshold, and a second number of second spatio-temporal position coordinates corresponding to spatial distances less than or equal to the distance threshold;
determining a first ratio of the first number to a total number of first spatio-temporal position coordinates, and a second ratio of the second number to a total number of second spatio-temporal position coordinates; and
determining a maximum value of the first ratio and the second ratio as the similarity between the two persons.

9. The method according to claim 1, wherein performing person detection on the video images, to determine, according to the obtained person detection result, the image set corresponding to at least one person among a plurality of persons includes:
performing the person detection on the video images to obtain person images including detection information, the person detection including at least one of face detection and body detection, wherein in a case where the person detection includes the face detection, the detection information includes face information; and in a case where the person detection includes the body detection, the detection information includes body information; and
determining, according to the person images, the image set corresponding to the at least one person among the plurality of persons.

10. The method according to claim 9, wherein determining, according to the person images, the image set corresponding to the at least one person among the plurality of persons includes:
clustering the person images including the face information to obtain a face clustering result, the face clustering result including at least one face identity for the person images including the face information;
clustering the person images including the body information to obtain a body clustering result, the body clustering result including at least one body identity for the person images including the body information; and
determining, according to the face clustering result and the body clustering result, the image set corresponding to the at least one person among the plurality of persons.

11. The method according to claim 10, wherein determining, according to the face clustering result and the body clustering result, the image set corresponding to the at least one person among the plurality of persons includes:
determining corresponding relationships between face identities and body identities in at least one person image including the face information and the body information; and
obtaining, according to a first corresponding relationship in the corresponding relationships, person images including the face information and/or the body information in the first corresponding relationship from the person images to form an image set corresponding to one person.

12. The method according to claim 11, wherein determining corresponding relationships between face identities and body identities in at least one person image including the face information and the body information includes:
obtaining face identities corresponding to the face information and body identities corresponding to the body information in the person images including the face information and the body information;
grouping the person images including the face information and the body information according to body identities to which the person images correspond, to obtain at least one body image group, person images in the same body image group having the same body identity; and
determining, for a first body image group in the body image groups, face identities respectively corresponding to at least one person image in the first body image group, and determining, according to the number of person images corresponding to at least one face identity in the first body image group, corresponding relationships between face identities and body identities in the person images in the first body image group.

13. The method according to claim 11, wherein determining corresponding relationships between face identities and body identities in at least one person image including the face information and the body information includes:
obtaining face identities corresponding to the face information and body identities corresponding to the body information in the person images including the face information and the body information;
grouping the person images including the face information and the body information according to face identities to which the person images correspond, to obtain at least one face image group, person images in the same face image group having the same face identity; and
determining, for a first face image group in the face image groups, body identities respectively corresponding to at least one person image in the first face image group, and determining, according to the number of person images corresponding to at least one body identity in the first face image group, corresponding relationships between face identities and body identities in the person images in the first face image group.

14. The method according to claim 11, wherein determining, according to the face clustering result and the body clustering result, the image set corresponding to the at least one person among the plurality of persons includes:
determining, for person images including the face information and not belonging to the image set, an image set corresponding to at least one person according to face identities of the person images.

15. The method according to claim 1, wherein, after determining companions among the plurality of persons according to the track information of the plurality of persons, the method further comprises at least one of:
determining a marketing plan for the companions according to the companions among the plurality of persons; and
determining an abnormal person among the companions.

16. An electronic device, comprising:
a processor; and
a memory configured to store processor executable instructions,
wherein the processor is configured to invoke the instructions stored in the memory so as to:
obtain video images respectively captured by a plurality of image capture devices deployed in different areas during a preset time period;
perform person detection on the video images to determine, according to an obtained person detection result, an image set corresponding to at least one person among a plurality of persons, the image set including person images;
determine track information of the at least one person according to position information of the plurality of image capture devices, the image set corresponding to the at least one person, and time for capturing the person images; and
determine companions among the plurality of persons according to track information of the plurality of persons.

17. The electronic device according to claim 16, wherein
determining the track information of the at least one person according to the position information of the plurality of image capture devices, the image set corresponding to the at least one person, and time for capturing the person images includes:
determine, for at least one person image in the image set corresponding to the at least one person, first position information of a target person in the person image in a video image corresponding to the person image;
determine a spatial position coordinate of the target person in a spatial coordinate system according to the first position information and second position information, the second position information being position information of an image capture device for capturing the video image corresponding to the person image;
obtain a spatio-temporal position coordinate of the target person in a spatio-temporal coordinate system according to the spatial position coordinate and time for capturing the video image corresponding to the person image; and
obtain the track information of the at least one person in the spatio-temporal coordinate system according to spatio-temporal position coordinates of the plurality of persons.

18. A system for detecting companions, comprising the plurality of image capture devices disposed in different areas and the electronic device according to claim 17, wherein
the plurality of image capture devices are configured to capture the video images, and send the video images to the electronic device.

19. The system according to claim 18, wherein the electronic device is integrated in the image capture devices.

20. A non-transitory computer-readable storage medium having computer program instructions stored thereon, wherein the computer program instructions, when executed by a processor, is caused to perform the operations of:
obtaining video images respectively captured by a plurality of image capture devices deployed in different areas during a preset time period;
performing person detection on the video images, to determine, according to an obtained person detection result, an image set corresponding to at least one person among a plurality of persons, the image set including person images;
determining track information of the at least one person according to position information of the plurality of image capture devices, the image set corresponding to the at least one person, and time for capturing the person images; and
determining companions among the plurality of persons according to track information of the plurality of persons.
